(19) United States
(12) Patent Application Publication
(10) Pub. No.: US 2022/0001658 A1
(43) Pub. Date: Jan. 6, 2022

(54) PANEL POSITION ALIGNMENT DEVICE

(71) Applicant: LG CHEM, LTD., Seoul (KR)

(72) Inventors: Beom Seok Lee, Daejeon (KR); Chan Soo Kim, Daejeon (KR); Sung Hyun Baek, Daejeon (KR); Yu Jin Lim, Daejeon (KR)

(21) Appl. No.: 17/291,253

(22) PCT Filed: Feb. 7, 2020
(86) PCT No.: PCT/KR2020/001795

§ 371 Date: May 4, 2021

(30) Foreign Application Priority Data
Feb. 22, 2019 (KR) 10-2019-0021187

(51) Int. Cl. B32B 37/00

(52) U.S. Cl. CPC B32B 37/0046

(57) ABSTRACT

A panel alignment apparatus for easily aligning a rectangular panel and preventing damage to an optical film during alignment, where the optical film is bonded to the panel such that one or more sides of the optical film protrude from the panel.

### CROSS-REFERENCE TO RELATED APPLICATIONS

This application is a U.S. national stage of international Application No. PCT/KR2020/001795, filed on Feb. 7, 2020, which claims priority from KR 10-2019-0021187, filed on Feb. 22, 2019, the contents of which are incorporated as if fully set forth herein.

### TECHNICAL FIELD

The present disclosure relates to a panel alignment apparatus for aligning a rectangular panel to which an optical film is bonded so that at least one side of the optical film protrudes from one side of the rectangular panel.

### BACKGROUND

A display unit is fabricated by bonding an optical film to a panel, the optical film including various functional films such as a polarizing film, a phase difference film and/or a protective film.

In general, when the optical film is bonded to one surface of the panel, corresponding to a screen side seen by an observer, the optical film is cut to be the same size as the panel or to be smaller than the panel, and then bonded to the panel.

The bezels of display units which are recently mass-produced tend to be narrowed. Such a display unit having a narrow bezel is fabricated through a process of cutting an optical film to be larger than a screen-side surface of a panel, bonding the optical film to the screen-side surface of the panel, and re-cutting the optical film to a bonding size corresponding to the screen-side surface of the panel. Before the optical film is re-cut after the optical film is cut to be larger than the screen-side surface of the panel and bonded to the screen-side surface of the panel, a process of aligning the panel is required for automating a mounting process of TAB (Tape Automated Bonding), PCB (Printed Circuit Board) and the like.

In general, a stopper used for panel alignment is in direct contact with a side surface of the panel to which the optical panel, which is smaller than or the same size as the screen-side surface, is bonded. Thus, the following problems do not occur: the optical film is damaged or the panel is not easily aligned due to interference with the optical film. However, when such a stopper is used to align a panel to which an optical film larger than a screen-side surface is bonded, the stopper may come in contact with the optical film protruding from the panel, and thus damage the optical film. Furthermore, when the stopper comes in contact with the panel, it is difficult to align the panel as intended due to interference with the optical film.

FIG. 1 is a schematic illustration of a panel to which an optical film larger than the panel is bonded and a panel alignment apparatus according to related art, and FIG. 2 is a cross-sectional view along the I-I′ line of FIG. 1.

As illustrated in FIG. 1, an optical film 2 is bonded to one surface of a panel 1 such that three sides of the optical film protrude from three sides 1b, 1c and 1d, respectively, of the panel 1, but does not protrude from the remaining fourth side 1a.

The related art panel alignment apparatus includes a plurality of stoppers 3 to 6 arranged along the four sides of the panel 1 so as to be spaced apart from each other.

The stoppers 3 to 6 may have a circular horizontal cross-section.

In order to align panel 1, the stoppers 3 and 4 disposed on the left and right sides in FIG. 1 may be moved toward each other, and the stoppers 5 and 6 disposed on the top and bottom in FIG. 1 may be moved toward each other. Thus, the stoppers may be placed close to the respective side surfaces of panel 1.

In general, the upper ends of stoppers 3 to 6 are placed at a higher level than one surface of panel 1. Thus, while the stoppers 3 to 6 are moved toward the side surfaces of panel 1, the sides 2b, 2c and 2d of the optical film 2, which protrude from the corresponding sides of the one surface of panel 1, may be brought in contact with stoppers 4 to 6. At this time, the sides 2b, 2c and 2d of the optical film 2, which are in contact with stoppers 4, 5 and 6, may not be placed in parallel to sides 1b, 1c and 1d of panel 1, and may be partially bent. In this case, the optical film 2 may be damaged, and the plurality of stoppers located on the respective sides may not form the same gap with the side surfaces of the panel 1, which makes it impossible to achieve the intended alignment of panel 1.

The related art is technical information which the present inventor has retained to derive embodiments of the present disclosure or has acquired during the process of deriving the present disclosure. The related art is not necessarily a publicly known technique which is published to the public before the application of the present disclosure.

### SUMMARY

Various exemplary embodiments are directed to a panel alignment apparatus capable of easily aligning a rectangular panel and preventing damage to an optical film, when the panel, to which an optical film is bonded so that one or more sides of the optical film protrude from the sides of the panel, is aligned.

In an exemplary embodiment, there is provided a panel alignment apparatus for aligning a rectangular panel to which an optical film is bonded so that at least one side of the optical film protrudes from one side of the panel. The panel alignment apparatus may include two pairs of guide units, wherein each pair of guide units are disposed adjacent to two sides of the panel, respectively, and the two pairs of guide units face each other. At least one of the pairs of guide units may be moved to maintain a predetermined distance therebetween for alignment of the panel. Among the pairs of guide units, the guide units disposed on protruding sides of the optical film may include bars extended in parallel to the protrusion sides of the panel when a predetermined distance is maintained between each pair of guide units.

An exemplary embodiment is a panel alignment apparatus for aligning a rectangular panel to which an optical film is bonded so that at least one side of the optical film protrudes from one side of the panel. The panel alignment apparatus may include two pairs of guide units, wherein each guide unit of the pair of guide units is disposed adjacent to opposite sides of the panel, respectively, which face each other. At least one of the pairs of guide units may be moved to maintain a predetermined distance therebetween for alignment of the panel. Among the pairs of guide units, the guide units disposed on the sides of the panel corresponding to the optical film protruding from the sides of the panel, may include stoppers whose one ends adjacent to a bonding surface of the panel, to which the optical film is bonded, do not protrude beyond the bonding surface, when a predetermined distance is maintained between each pair of guide units.

In accordance with the exemplary embodiments of the present disclosure, the panel alignment apparatus can easily align a rectangular panel and prevent damage to an optical film, when the alignment of the panel, to which an optical film is bonded so that one or more sides of the optical film protrude from the sides of the panel, is performed.

### BRIEF DESCRIPTION OF THE DRAWINGS

FIG. 1 is a schematic illustration of a panel to which an optical film larger than the panel is bonded and a panel alignment apparatus according to related art.

FIG. 2 is a cross-sectional view along the I-I′ line of FIG. 1.

FIG. 3 is a schematic illustration of an initial state before the alignment of a panel is performed by a panel alignment apparatus in accordance with an exemplary embodiment of the present disclosure.

FIG. 4 is a schematic illustration of an exemplary embodiment a panel alignment apparatus of the present disclosure.

FIG. 5 is a cross-sectional view along the III-III′ line of FIG. 4.

FIG. 6 is a schematic illustration of another exemplary embodiment of a panel alignment apparatus .

FIG. 7 is a cross-sectional view along the IV-IV′ line of FIG. 6.

FIGS. 8 and 9 are schematic illustrations of another exemplary embodiment of a panel alignment apparatus.

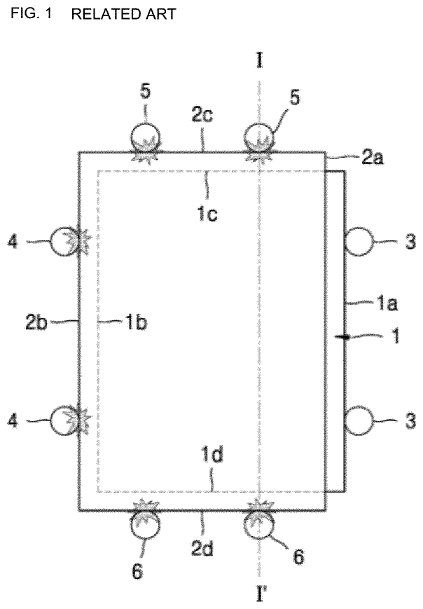

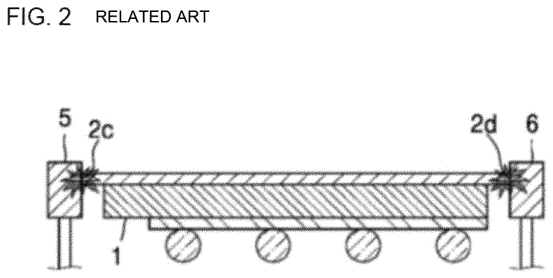

### DETAILED DESCRIPTION

The present disclosure will be clearly understood with reference to exemplary embodiments described herein and the accompanying drawings. However, the present disclosure may be embodied in different forms and should not be construed as limited to the exemplary embodiments set forth herein. Rather, these exemplary embodiments are provided so that this disclosure will be thorough and complete, and will fully convey the scope of the present disclosure to those skilled in the art. The present disclosure is only defined by the scope of claims. Terms used in this specification are used for describing exemplary embodiments while not limiting the present disclosure. The terms of a singular form in this specification include plural forms unless referred to the contrary. The meaning of ‘comprise’ and ‘comprising’ used in the specification specifies a component, step, operation, and/or element but does not exclude one or more other components, steps, operations, and/or elements. The terms such as first and second may be used to describe various components, but the components should not be limited by the terms. The terms are used only to distinguish one component from another component.

Hereafter, the present disclosure will be described in detail with reference to the accompanying drawings.

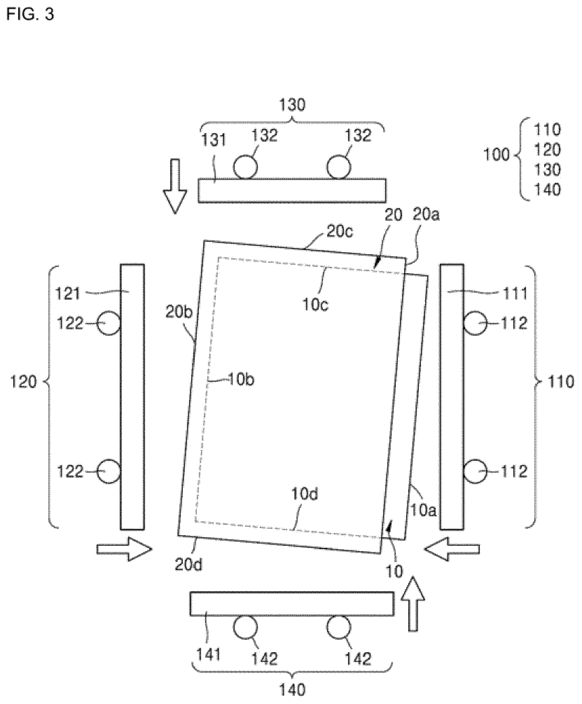

FIG. 3 is a schematic plan view of the panel alignment apparatus before the panel is aligned in accordance with an exemplary embodiment of the present disclosure.

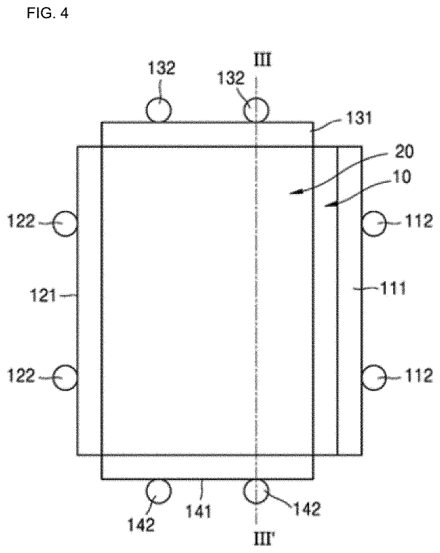

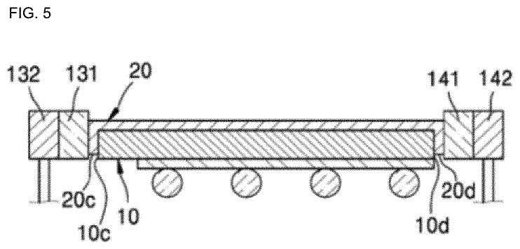

FIG. 4 is a schematic plan view of an exemplary embodiment in which the panel is aligned by the panel alignment apparatus in accordance with an exemplary embodiment of the present disclosure, and FIG. 5 is a schematic cross-sectional view along the III-III′ line of FIG. 4.

The panel alignment apparatus in accordance with an exemplary embodiment of the present disclosure may be an apparatus for aligning a rectangular panel to which an optical film is bonded so that at least one side of the optical film protrudes from one side of the panel.

As illustrated in FIG. 3,the optical film 20 may be bonded to the panel 10 such that three sides 20b, 20c and 20d of the optical film 20 protrude from corresponding sides 10b, 10c and 10d of the rectangular panel 10, respectively, and a right side 20 a does not protrude.

The panel alignment apparatus 100 may include a pair of guide units 110-120 and a pair of guide units 130-140. Each pair of guide units may be disposed adjacent to opposite sides of the panel 10 such that each guide unit of a pair of guide units is facing the other guide unit of the pair of guide units. In the present embodiment, first and second guide units 110 and 120 disposed adjacent to the left and right sides 10a and 10b of the panel 10, respectively, and which face each other, may form the pair of guide units 110-120, and third and fourth guide units 130 and 140 disposed adjacent to the top and bottom sides 10c and 10d of the panel 10, respectively, and which face each other, may form the pair of guide units 130-140.

At least one of the pairs of guide units 110-120 and 130-140 may be moved to maintain a predetermined distance for alignment of the panel 10. The predetermined distance may indicate a distance between the pair of guide units 110-120 or 130-140 when the guide units 110, 120, 130 and 140 are disposed closest to the side surfaces of the panel 10, with the pair of guide units 110-120 or 130-140 disposed such that they are parallel to each other. In the present embodiment, the guide units 110, 120, 130 and 140 may be movably configured.

In the present specification, the sides 10b, 10c and 10d of the panel 10, corresponding to the protruding sides 20b, 20c and 20d, respectively, of the optical film 20 may be referred to as protrusion sides of the panel 10.

Among the pairs of guide units 110-120 and 130-140, the guide units 120, 130 and 140 which are disposed on the protrusion sides 10b, 10c and 10d of the panel 10, corresponding to the protruding sides 20b, 20c and 20d of the optical film 20, may include bars 121, 131 and 141 which extend in parallel to the protrusion sides 10b, 10c and 10d of the panel 10 when the predetermined distance is maintained between the pair of guide units 110-120 or 130-140. In the present embodiment, the guide unit 110 disposed on the other side 10a except the protrusion sides 10b, 10c and 10d of the panel 10 may also include a bar 111 which extends in parallel to the corresponding side 10a of the panel 10.

The guide units 110, 120, 130 and 140 may also include stoppers 112, 122, 132 and 142, respectively, which have been used in related art and have a circular horizontal cross-section. In this case, the bars 111, 121, 131 and 141 may be disposed between the stoppers 112, 122, 132 and 142 and the panel 10, and fixed to the stoppers 112, 122, 132 and 142.

The bars 121, 131 and 141 may have surfaces facing the panel 10, and which are substantially parallel to the side surfaces of the panel 10 on the protrusion sides 10b, 10c and 10d when the pair of guide units 110-120 or 130-140 maintain the predetermined distance therebetween. The other bar 111 may also have a surface facing the panel 10, and which is substantially parallel to the panel 10 on the side 10a when the pair of guide units 110-120 or 130-140 maintain the predetermined distance therebetween. When the surfaces facing the panel 10 are substantially parallel to the side surfaces of the panel 10 on the side 10a and the protrusion sides 10b, 10c and 10d, it may indicate that the bars have flat surfaces like the side surfaces of the panel 10 or have curved surfaces whose respective curvatures are close to zero even though the bars include the curved surfaces.

In an exemplary embodiment in which alignment of the panel is performed, one end of each of the bars 111, 121, 131 and 141 adjacent to the bonding surface of the panel 10, to which the optical film 20 is bonded, may protrude from the bonding surface of the panel 10. Similarly, one end of each of the stoppers 112, 122, 132 and 142 adjacent to the bonding surface of the panel 10, to which the optical film 20 is bonded, may protrude from the bonding surface of the panel 10.

However, the bars 121, 131 and 141 may be extended in parallel to the protrusion sides 10b, 10c and 10d, respectively, of the panel 10, and have surfaces facing the panel 10, and which are parallel to the side surfaces of the panel 10. Thus, the bars 121, 131 and 141 may be brought into surface contact with the corresponding protrusion sides 10b, 10c and 10d of the panel 10 on the sides 20b, 20c and 20d, respectively, of the optical film 20, which protrude from the protrusion sides 10b, 10c and 10d of the panel 10. That is, the bars 121, 131 and 141 in accordance with an exemplary embodiment of the present disclosure may not be brought into partial contact with the sides of the optical film, which protrudes from the protrusion sides of the panel, but be brought into surface contact with the sides of the optical film, unlike the plurality of stoppers according to related art. Thus, the bars 121, 131 and 141 can prevent damage to the optical film 20, and form the same gap in the longitudinal direction of the protrusion sides of the panel 10. Thus, the alignment of the panel 10 can be easily achieved.

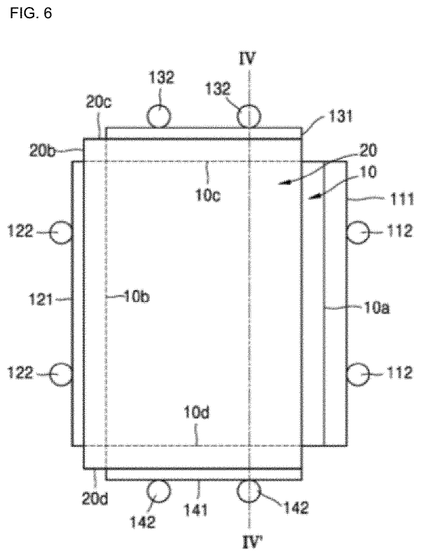

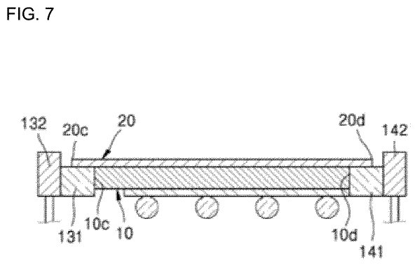

FIG. 6 is a schematic plan view of another exemplary embodiment in which the panel is aligned by the panel alignment apparatus, and FIG. 7 is a schematic cross-sectional view along the IV-IV′ line of FIG. 6.

Most components of this exemplary embodiment in which the panel is aligned are configured in the same manner as those in previous exemplary embodiments. Thus, the detailed descriptions thereof are omitted herein, and the following descriptions will be focused on differences therebetween.

In the exemplary embodiment illustrated in FIGS. 6 and 7, one end of each of the bars 111, 121, 131 and 141 adjacent to the bonding surface of the panel 10, to which the optical film 20 is bonded, may be located at a lower level than corresponding ends of each of the stoppers 112, 122, 132 and 142. More specifically, one of the ends of each of the bars 111, 121, 131 and 141 adjacent to the bonding surface of the panel 10, to which the optical film 20 is bonded, may be formed so as not to protrude from the bonding surface of the panel 10. Thus, when the bars 121, 131 and 141 are most adjacent to the side surfaces of the panel 10, at least one of two ends thereof may be located under the optical film 20. That is, since the bars 121, 131 and 141 may not be in contact with the optical film 20, damage to the optical film 20 can be further prevented. Furthermore, when the bars 121, 131 and 141 are most adjacent to the side surfaces of the panel 10, the bars 121, 131 and 141 do not interfere with the optical film 20, which makes it possible to further improve the alignment precision of the panel 10.

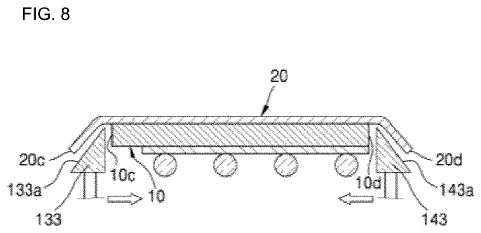

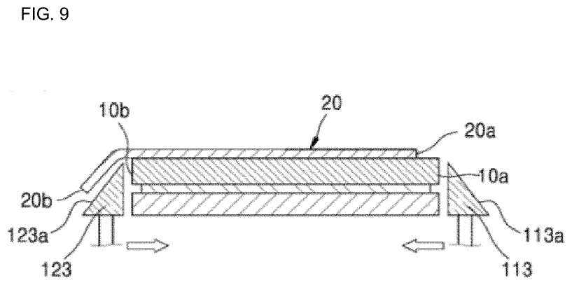

FIG. 8 is a schematic cross-sectional view of an exemplary embodiment in which the alignment of a panel is performed by a panel alignment apparatus in accordance with another exemplary embodiment of the present disclosure.

Since most components of the panel alignment apparatus of this exemplary embodiment are configured in the same manner as those of the panel alignment apparatus in previous exemplary embodiments, the detailed descriptions thereof are omitted, and the following descriptions will be focused on differences therebetween.

In the exemplary embodiment illustrated in FIG. 8, among the guide units 110, 120, 130 and 140, the guide units 120, 130 and 140 which are disposed on the protrusion sides 10b, 10c and 10d, respectively, of the panel 10, and correspond to the protruding sides 20b, 20c and 20d, respectively, of the optical film 20, may include stoppers 123, 133 and 143, and one end of each of the stoppers 123, 133 and 143 adjacent to a bonding surface of the panel 10, to which the optical film 20 is bonded, do not protrude from the bonding surface, when the predetermined distance is maintained between the pair of guide units 110-120 or 130-140. In this exemplary embodiment, the guide unit 110 disposed on the side 10a except the protrusion sides 10b, 10c and 10d of the panel 10 may also include a stopper 113, and one end of the stopper 113 adjacent to the bonding surface of the panel 10, to which the optical film 20 is bonded, does not protrude from the bonding surface, when the predetermined distance is maintained between the pair of guide units 110-120 or 130-140. In this exemplary embodiment, the stoppers 113, 123, 133 and 143 may replace the bars 111, 121, 131 and 141 and the stoppers 112, 122, 132 and 142 descried in the previously described exemplary embodiment.

The stoppers 113, 123, 133 and 143 may include inclined surfaces 113a, 123a, 133a and 143a which are inclined downward in a direction away from the panel 10. Therefore, while the alignment of the panel 10 is performed with the stoppers 123, 133 and 143 disposed most adjacent to side surfaces of the panel 10 on the protrusion sides 10b, 10c and 10d, the inclined surfaces 123a, 133a and 143a may smoothly support the sides 20b, 20c and 20d, respectively, of the optical film 20 protruding outward from the panel 10.

Each of the guide units 120, 130 and 140 may include the plurality of stoppers arranged in a direction parallel to the corresponding protrusion side of the panel 10, when the pair of guide units 110-120 or 130-140 maintain the predetermined distance therebetween. The guide unit 110 may include the plurality of stoppers 113 disposed on the other side 10a except the protrusion sides 10b, 10c and 10d of the panel 10 and arranged in a direction parallel to the side 10a of the panel 10, when the pair of guide units 110-120 or 130-140 maintain a predetermined distance therebetween.

For another example, the stoppers 123, 133 and 143 may extend in parallel to the protrusion sides 10b, 10c and 10d, respectively, of the panel 10, when the pair of guide units 110-120 or 130-140 maintain the predetermined distance therebetween. The stoppers 113 disposed on the other side 10a except the protrusion sides 10b, 10c and 10d of the panel 10 may also extend in parallel to the corresponding side 10a of the panel 10, when the pair of guide units 110-120 or 130-140 maintain a predetermined distance therebetween.

While various embodiments have been described above, it will be understood to those skilled in the art that the embodiments described are by way of example only. Accordingly, the disclosure described herein should not be limited based on the described embodiments.

1. A panel alignment apparatus for aligning a rectangular panel to which an optical film is bonded with at least one side of the optical film protruding from a side of the panel, the panel alignment apparatus comprising two pairs of guide units, wherein each guide unit of one pair of the two pairs of guide units is disposed adjacent to opposite sides of the panel and is positioned to face the other guide unit of the one pair of the two pairs of guide units
wherein at least one of the two pairs of guide units is moved to maintain a predetermined distance therebetween for alignment of the panel, and
wherein among the two pairs of guide units, each of the pair of guide units disposed adjacent to a side of the panel comprising the at least one side of the optical film protruding from a side of the panel comprises a plurality of bars, which are positioned parallel to the side of the panel comprising the at least one side of the optical film protruding from a side surface of the panel when a predetermined distance is maintained between each pair of guide units.

2. The panel alignment apparatus of claim 1, wherein a surface of each of the plurality of bars is parallel to and faces the side surface of the panel comprising the at least one side of the optical film protruding from a side of the panel.

3. A panel alignment apparatus for aligning a rectangular panel to which an optical film is bonded with at least one side of the optical film protruding from a side of the panel, the panel alignment apparatus comprising two pairs of guide units, wherein each guide unit of one pair of the two pairs of guide units is disposed adjacent to opposite sides of the panel and is positioned to face the other guide unit of the one pair of the two pairs of guide units,
wherein at least one of the pairs of guide units is moved to maintain a predetermined distance therebetween for alignment of the panel,
wherein among the pairs of guide units, each of the pair of guide units disposed adjacent to a side of the panel comprising the at least one side of the optical film protruding from a side of the panel comprises a plurality of stoppers
wherein an end of each of the plurality of stoppers adjacent to a bonding surface of the panel, to which the optical film is bonded, does not protrude beyond the bonding surface_{;} when a predetermined distance is maintained between each pair of guide units.

4. The panel alignment apparatus of claim 3, wherein each of the plurality of stoppers has an inclined surface which is inclined downward in a direction away from the panel.

5. The panel alignment apparatus of claim 3, wherein the plurality of stoppers are arranged in a direction parallel to the side of the panel comprising the at least one side of the optical film protruding from a side of the panel.

6. The panel alignment apparatus of claim 3, wherein the plurality of stoppers are extended in parallel to the side of the panel comprising the at least one side of the optical film protruding from a side of the panel.
